(19) United States
(12) Patent Application Publication
(10) Pub. No.: US 2008/0099141 A1
(43) Pub. Date: May 1, 2008

(54) Method of producing flexible laminates

(75) Inventors: Gregory E. Booth, Hilliard, OH (US); Randy A. Johnson, Hilliard, OH (US); Gary M. Carlson, Dublin, OH (US); Raymond S. Harvey, Worthington, OH (US); Thomas M. Moy, Hilliard, OH (US)

Correspondence Address: CONNOLLY BOVE LODGE & HUTZ LLP, 1875 EYE STREET, N.W., SUITE 1100, WASHINGTON, DC, 20036, US

(73) Assignee: Ashland Inc., Columbus, OH (US)

(21) Appl. No.: 11/586,499

(22) Filed: Oct. 26, 2006

(51) Int. Cl. C09J 101/00

(52) U.S. Cl. 156/331.7

(57) ABSTRACT

A method of producing a flexible laminate and a flexible laminate produced by the method are provided. The method involves laminating flexible substrates with a urethane adhesive and allowing the urethane adhesive to cure. The urethane adhesive comprises at least one polyisocyanate, at least one polyfunctional curative, at least one metal based catalyst and a catalyst blocking agent. The catalyst blocking agent allows for improved control of the curing rate of the urethane adhesive in the flexible laminate. The curing rate of the urethane adhesive can be controlled with heat or actinic radiation or both. The method allows for faster and more economical production of flexible laminates.

### TECHNICAL FIELD

The present disclosure relates to a method of producing flexible laminates. The method involves laminating at least two flexible substrates with a urethane adhesive. The urethane adhesive contains a blocking agent which allows the urethane adhesive to be cured under controlled conditions. The method allows for faster and more economical production of flexible laminates. The disclosure also relates to laminated flexible packaging produced from the method.

### BACKGROUND

Multiple layer flexible laminates laminated with adhesives are used in a wide variety of applications. The specific application of the flexible laminate drives the type and cost of a particular lamination technology. Urethane adhesives for flexible laminates offer excellent adhesion, clarity, processing and product resistance as well as 100% solids for environmental advantages. Flexible laminates can provide intense and colorful graphics that can be buried and protected within the laminated structure. Typically, 2 to 4 films are laminated together to produce a structure that possesses the properties of each incorporated film. Cost and product performance dictate which types of film substrates are used. For example, bottle labels, fresh cut produce, meat and cheese packaging often utilize aromatic urethane adhesives in flexible laminate packaging.

However, more demanding applications like hot-fill and retort typically use aliphatic urethane adhesives which often cure slower than aromatic urethane adhesives. Typically, flexible laminates produced from aliphatic urethanes requires 5-14 days to fully cure. Often hot rooms are utilized to store the laminated product at temperatures of 100-110° F. to shorten the urethane cure time to 3-5 days. Even shorter urethane cure times for the laminate are desirable to increase production rates and decrease costs. Ideally, the urethane adhesive should not cure until the urethane adhesive is applied between the substrate films and then should cure quickly after the substrates are laminated together.

### SUMMARY

The present disclosure relates to a method of producing flexible laminates and to flexible laminates produced by the method. The flexible laminates are useful in flexible laminate packaging. The method involves laminating flexible substrates with a urethane adhesive and allowing the urethane adhesive to cure. The urethane adhesive comprises at least one polyisocyanate, at least one polyfunctional curative, at least one metal based catalyst and a catalyst blocking agent. The catalyst blocking agent allows for improved control of the curing rate of the urethane adhesive in the flexible laminate. In various aspects of the disclosure, the curing rate of the urethane adhesive can be controlled with heat, radiation such as actinic radiation, e-beam radiation or a combination of these. Some examples of a heat source are heated NIP, infra-red lamps and microwave radiation.

Still other objects and advantages of the present disclosure will become readily apparent by those skilled in the art from the following detailed description, wherein it is shown and described only in the preferred embodiments, simply by way of illustration of the best mode. As will be realized, the disclosure is capable of other and different embodiments, and its several details are capable of modifications in various obvious respects, without departing from the disclosure. Accordingly, the description is to be regarded as illustrative in nature and not as restrictive.

### DETAILED DESCRIPTION AND VARIOUS MODES

The disclosed method for producing flexible laminates involves applying a urethane adhesive to at least one flexible substrate as a coating and laminating or bonding the adhesive coated flexible substrate to another flexible substrate with the adhesive between the substrates to form a flexible laminate. The adhesive is then cured to form a flexible laminate material. The flexible substrate can be any type of flexible material suitable for lamination or for packaging. Plastic sheets are typically utilized. Flexible metal sheets such as aluminum and metalized plastic sheets can also be utilized. The flexible laminates are useful as packaging materials.

Typical plastic sheets include polyethylene (PE) sheet, polypropylene (PP) sheet, PE/PP sheet, oriented PP, metalized PET, mono-axially oriented PP, nylon sheet, polyester sheet, mylar sheet, styrenic sheet, polycarbonate sheet, acrylic sheet, acetal sheet, Delrine® sheet, Lexan® sheet, Micarta® sheet, Perspec® sheet, Acrylite® sheet, PET sheets, ABS sheet, PVC sheet, PTFE sheet, HIPS sheet, EVOH sheet and PP/EVOH sheet. Sheet thickness ranges from about 0.1 mil to about 50 mil, more typically from about 1 mil to about 20 mil.

Other examples of flexible substrates that can be utilized include silicon oxide or aluminum oxide coated plastics such as polyester, nylon and PP.

The urethane adhesive can be any type of urethane adhesive formulation comprising at least one polyisocyanate, at least one polyfunctional curative and a metallic based catalyst. The urethane adhesive also comprises at least one catalyst blocking agent. In addition, the urethane adhesive may optionally contain a solvent. The solvents can include ketones such as MEK and MIBK, aromatic solvents such as toluene and xylene, aliphatic solvents like hexane and cyclohexane, esters like ethyl acetate and other solvents like THF. The solvents are used in an amount from about 20% to about 80% by weight of the final adhesive mixture. The catalyst blocking agent provides for more control of the urethane curing process. More control of the urethane curing process leads to improved product production rates and product quality. The at least one catalyst blocking agent is a mercapto compound or a polyphenol with adjacent hydroxyl groups or a combination of both a mercapto compound and a polyphenol with adjacent hydroxyl groups.

The polyisocyanate compound is not limited and can include aromatic, aliphatic or, mixed aromatic/aliphatic isocyanates and polymeric isocyanates. Further, alcohol-modified and other modified isocyanate compositions find utility in the disclosure. Polyisocyanates preferably have from about 2-4 isocyanate groups per molecule. Suitable multi-isocyanates for use in the present disclosure include, for example, hexamethylene diisocyanate, hexamethylene diisocyanate trimer, tetramethylxylylene diisocyanate, 4,4′-toluene diisocyanate (TDI), diphenylmethane diisocyanate (MDI), polymethyl polphenyl isocyanate (Polymeric MDI or PAPI), m- and p-phenylene diisocyanates, bitolylene diisocyanate, triphenylmethane triisocyanate, tris-(4-isocyanatophenyl)thiophosphate, cyclohexane diisocyanate (CHDI), bis-(isocyanatomethyl)cyclohexane (H₆XDI), dicyclohexylmethane diisocyanate (H₁₂MDI), trimethylhexane diisocyanate, dimer acid diisocyanate (DDI), dicyclohexylmethane diisocyanate, and dimethyl derivatives thereof, trimethyl hexamethylene diisocyanate, lysine diisocyanate and its methyl ester, isophorone diisocyanate, methyl cyclohexane diisocyanate, methylenedicyclohexane diisocyanate, isophorone diisocyanate, 1,5-naphthalene diisocyanate, triphenyl methane triisocyanate, xylylene diisocyanate and methyl and hydrogenated derivatives thereof, polymethylene polyphenyl isocyanates, chlorophenylene-2,4-diisocyanate and mixtures thereof. Aromatic and aliphatic polyisocyanate dimers, trimers, oligomers, polymers (including biuret and isocyanurate derivatives) and isocyanate functional prepolymers often are available as preformed packages and such packages are suitable for use in the present disclosure. The flexible laminate adhesive may have a molar ratio of isocyanate to hydroxy of from about 0.7 to about 2.0.

The polyfunctional curative component of the urethane adhesive composition is not limited and can include any type of polyfunctional compound capable of reacting with isocyanates including polyols and polyamines.

The polyol compound is not limited and can include diol, triols, tetrols and mixtures thereof. Typically, the polyol compound is a polyhydroxy compound, a polyhydroxy oligomer or a polyhydroxy polymer.

Hydroxy compounds useful in the curable urethane compositions include hydroxypolyesters, hydroxypolyethers, hydroxypolythioesters, hydroxypolyacetals, hydroxypolycarbonates, dimeric fatty alcohols, esteramides, polyetherpolyols, polyesterpolyols, polycarbonatepolyols, ethylene glycol, triethylene glycol, tetraethylene glycol, 1,2- and 1,3-propanediol, 1,4- and 1,3-butanediol, 1,6-hexanediol, 1,8-octanediol, neopentyl glycol, 1,4-bis-(hydroxymethyl)-cyclohexane, bis-(hydroxymethyl)-(tricycle-[5.2.1.0^{2.6}]-decane or 1,4-bis-(2-hydroxyethoxy)-benzene, 2-methyl-1,3-propanediol, 2,2,4-trimethylpentanediol, 2-ethyl-1,3-hexanediol, dipropylene glycol, polypropylene glycols, dibutylene glycol, polybutylene glycols, bisphenol A, tetra-bromobisphenol A, glycerol, trimethylolpropane, 1,2,6-hexanetriol, 1,2,4-butanetriol, pentaerythritol, quinitol, mannitol, sorbitol, methylglycoside 1,4:3,6-dianhydrohexitol and mixtures thereof. The flexible laminate adhesive may have a molar ratio of isocyanate to hydroxyl of from about 0.7 to about 2.0.

The hydroxy compound also may be a hydroxy urethane prepolymer which can be a polyol or monomeric alcohol provided from a polyester, polyether, polyurethane, polysulfide, or the like. Ethylenic unsaturation even can be provided by the monomeric alcohol or polyol itself or can be reacted onto a polyol or monomeric alcohol subsequently by conventional reaction schemes, if such unsaturation is desirable. Conventional reaction schemes call for the reaction of a monomeric alcohol or polyol with, for example, acrylic acids, acrylyl halides, acrylic-terminated ethers, acrylic or methacrylic anhydrides, isocyanate-terminated acrylates, epoxy acrylates, and the like. Further reaction schemes for formulating hydroxy urethane prepolymers include reaction of a hydroxy-acrylate monomer, hydroxy methacrylate monomer, or an allyl ether alcohol with a cyclic anhydride such as, for example, the anhydrides: maleic, phthalic, succinic, norborene, glutaric, and the like. Unsaturated polyol-polyesters optionally then can be reacted with a suitable oxirane, such as, for example, ethylene oxide, propylene oxide, glycidyl acrylate, allyl glycidyl ether, alpha-olefin epoxides, butyl glycidyl ether, and the like. Suitable allyl alcohols include, for example, trimethylolpropane monoallyl ether, trimethylol propane diallyl ether, allyl hydroxylpropylether, and the like.

The metallic based catalyst component of the urethane adhesive composition is not limited and can include any metal based compound capable of catalyzing the reaction between the polyisocyanate and the polyfunctional curative. Metal compounds based on tin, bismuth, germanium, cobalt or manganese may be used to catalyze the reaction. Typically, the metal compound is a tin compound, a bismuth compound or a combination of both a tin compound and a bismuth compound. More typically, the metal compound is selected from dibutyltindilaurate, stannous acetate, stannic oxide, stannous octoate, dibutyltin dioctoate, tin mercaptides, stannous citrate, stannous oxylate, stannous chloride, stannic chloride, tetra-phenyl tin, tetra-butyl tin, tri-n-butyl tin acetate, di-alkyl tin dicarboxylates, dimethyl tin dichloride, bismuth tricarboxylates, bismuth nitrate, bismuth halides, bismuth sulfide, basic bismuth dicarboxylates, and mixtures thereof. Typically, the catalyst concentration ranges from about 0.005 to about 0.5 weight % based on the total amount of adhesive.

The at least one blocking agent component of the urethane adhesive composition includes compounds that can reversibly block the catalyst activity of the metallic based catalyst component. Typically, the catalyst blocking agent is a mercapto compound or a polyphenol with adjacent hydroxyl groups or a combination of both a mercapto compound and a polyphenol with adjacent hydroxyl groups.

The mercapto compound is not limited and can include any mercapto compound capable of reversibly inhibiting the catalytic activity of the metallic based catalyst. Typically, the mercapto compound is selected from trimethylol propane tri-(3-mercapto propionate), pentaerythritol tetra-(3-mercapto propionate), glycol di-(3-mercapto propionate), glycol dimercapto acetate, trimethylol propane trithioglycolate, mercapto diethyl ether, ethane dithiol, thiolactic acid, mercapto propionic acid and esters thereof, thiophenol, thio acetic acid, 2-mercapto ethanol, 1,4-butanedithiol, 2,3-dimercapto propanol, toluene-3,4-dithiol, alpha,alpha′-dimercapto-para-xylene, thiosalicylic acid, mercapto acetic acid, dodecane dithiol, didodecane dithiol, di-thio phenol, di-para-chlorothiophenol, dimercapto benzothiazole, 3,4-dimercapto toluene, allyl mercaptan, benzyl mercaptan, 1,6-hexane dithiol, 1-octane thiol, para-thiocresol, 2,3,5,6-tetrafluorothiophenol, cyclohexyl mercaptan, methylthioglycolate, various mercapto pyridines, dithioerythritol, 6-ethoxy-2-mercaptobenzothiazole, d-limonene dimercaptan γ-mercapto silane, and mixtures thereof. Typically, the molar ratio of mercapto groups in the mercaptan to the metal in the metal catalyst ranges from about 2:1 to about 500:1.

The polyphenol with adjacent hydroxyl groups can be any polyphenol compound with adjacent hydroxyl groups. Typical examples include catechol (1,2-dihdroxybenzene), pyrogallol, 3-methoxy catechol, and other catechol derivatives including catechol derivatives with the structure given in formula I

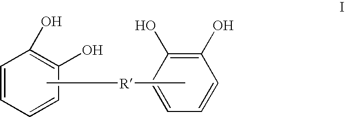

where R′ is a divalent organic group. Typically, the molar ratio of hydroxyl groups from the polyphenol to the metal in the metal catalyst ranges from about 2:1 to about 500:1.

When the urethane adhesive composition contains the polyphenol with adjacent hydroxyl groups the adhesive composition may optionally contain a tertiary amine containing substituents such as alkyl, alkanol, aryl, cycloaliphatic, and mixtures thereof. Additionally, heterocyclic tertiary amines may be suitable for use in the invention also. Representative tertiary amines include, for example, triethylamine, dimethylethylamine, tetramethylethylenediamine, trimethylamine, tributylamine, dimethylbenzylamine, dimethylcyclohexylamine, dimethylethanolamine, diethylethanolamine, triethanolamine, pyridine, 4-phenylpropylpyridine, 2,4,6-collidine, quinoline, tripropylamine, isoquinoline, N-ethylmorpholine, triethylenediamine, and the like and mixtures thereof. Additionally, it is conceivable to use amine oxides and quaternary ammonium amines. A myriad of proprietary tertiary amine activators currently are available and should also function in the process.

The blocking effect of the catalyst blocking agent can be reversed by heating the flexible laminate. The blocking effect of the mercaptan or polyphenol is eliminated by reaction of mercaptan or polyphenol with isocyanate. With heating, the urethane adhesive cures at a more controlled rate by quickly reactivating the catalyst. With the catalyst reactivated, the polyisocyanate and the polyfunctional curative react to form the cured urethane adhesive and form the finished flexible packaging. Typically, the flexible laminate is heated from about 25° C. to about 100° C., more typically from about 25° C. to about 60° C. and even more typically from about 25° C. to about 50° C.

When a mercapto compound blocking agent is utilized, the blocking effect of the catalyst can also be reversed by including an olefinic compound in the urethane adhesive composition and exposing the flexible laminate to actinic radiation such as UV radiation or e-beam radiation. The radiation causes the mercapto compound to react with the olefinic compound and this eliminates the blocking effect of the mercapto compound thus reactivating the catalyst. With the catalyst reactivated, the urethane in the flexible laminate cures forming the finished flexible packaging.

The olefinic compound is not limited and can include any olefin usable in a urethane adhesive composition. Non-limiting examples include diallyl phthalate, acrylic acid, methacrylic acid, alkyl acrylate, alkyl methacrylate, acrylamide and mixtures thereof. The molar ratio of the olefinic groups in the olefin to the mercapto groups in the mercaptan ranges from about 0.5:1 to about 2:1.

The following examples are for illustrative purposes only and are not intended to limit the scope of the claims.

In general, the flexible laminate is produced by compounding the components of the urethane adhesive with a mixing device such as a standard mixing blade or a static mixer. Typically, the compounded urethane adhesive is applied to a laminating head and the adhesive is transferred to a flexible substrate. The laminating head is typically set to a temperature from about 25° C. to about 50° C., more typically from about 25° C. to about 45° C. The coat thickness of the adhesive applied onto the substrate is typically from about 0.01 mils to about 0.250 mils, more typically from about 0.03 mils to about 0.175 mils and even more typically from about 0.05 to about 0.150 mils.

After the adhesive is applied to the first flexible substrate (primary film), the first flexible substrate is laminated or bonded to a second flexible substrate (secondary film) with the adhesive layer between the primary and secondary film. The flexible laminate has the layered structure primary film/adhesive/secondary film. This process can be repeated to form a multiple layer laminate. For example, the secondary layer of the flexible laminate about can have urethane adhesive applied to its surface and then a tertiary film can be married to the flexible laminate to form the laminated structure primary film/adhesive/secondary film/adhesive/tertiary film. This process can be repeated to achieve any desired number of layers in any desired order of flexible substrates (films).

Once the at least two flexible substrates are laminated or bonded together, to form a flexible laminate, the laminate is passed through a nip between two rolls under pressure. One or both of the rolls may be heated. The nip pressure typically is about 0.1 pli to about 100 pli. One or both of the rolls may be heated to about 25° C. to about 100° C., more typically from about 25° C. to about 60° C. and even more typically from about 25° C. to about 50° C.

For multiple layer laminates (more than 2 flexible substrates) the laminate can be passed through the nip for each succeeding layer of adhesive and flexible substrate or the entire multiple flexible laminate can be formed first then passed through the nip. The urethane adhesive is then allowed to cure with time or by heating or by exposure to radiation depending upon the urethane adhesive formulation and the type of flexible packaging produced. The radiation can be applied before or after the nipping process. For example, a urethane adhesive containing a mercaptan or polyphenol with adjacent hydroxyl groups can cure over time because the blocking effect of the mercaptan or polyphenol compounds is reduced as the polyisocyanate in the adhesive formulation reacts with them which in turn de-blocks the catalyst which then catalyzes the reaction between the polyisocyanate and polyfunctional curative. The process is accelerated by heating. Alternatively, for formulations containing a mercaptan and an olefinic compound, exposure to radiation causes the mercaptan and olefinic compound to react thus eliminating the blocking effect of the mercaptan. The de-blocked catalyst can then quickly cure the urethane adhesive.

If heat is applied to accelerate the urethane adhesive cure rate the heat may be applied by heating one or both of the nip rolls. If radiation is applied to accelerate the urethane cure rate, the urethane adhesive coated on the flexible substrate is subjected to radiation before or after the nipping process. For example, if at least one of the two flexible substrates is transparent to radiation, the adhesive may be exposed to radiation after the nipping process. In either case, some heat may be applied to facilitate adhesive wet out. The following non-limiting examples illustrate some of the embodiments of the disclosure.

Four flexible laminate examples were prepared using the general procedures described above. Processing conditions for the laminations and the flexible substrates (films) used are given below in Table 1. The urethane adhesive formulations are given in Table 2.

TABLE 1
Process conditions for producing the flexible laminated packaging.

| Process Parameters | | |
|---|---|---|
| Application roll temperature | 35° | C. |
| NIP roll temperature | 45° | C. |
| Line speed | 40 | fpm |
| Adhesive coat thickness | 0.11 | mils |
| Flexible substrates (films) | | |
| Primary film | 48 | g PET |
| Secondary film | 2.0 | mil LDPE |

TABLE 2
Urethane Adhesive Formulations

| Urethane Formulation | 1 | 2 | 3 | 4 | 5 | 6 | 7 |
|---|---|---|---|---|---|---|---|
| Polyisocyanate, wt % | | | | | | | |
| Hexamethylene | 100 | 100 | 100 | 100 | 100 | 96.0 | 50 |
| Diisocyanate | | | | | | | |
| Trimer | | | | | | | |
| Catechol | 0 | 0 | 0 | 0 | 0 | 2.24 | 0 |
| Dibutyl Tin | 0 | 0 | 0 | 0 | 0 | 0.07 | 0 |
| Dilaurate | | | | | | | |
| (Catalyst) | | | | | | | |
| MEK | 0 | 0 | 0 | 0 | 0 | 2.02 | 50 |
| Polyfunctional Curative, | | | | | | | |
| wt % | | | | | | | |
| Polypropylene | 57.75 | 57.75 | 57.75 | 57.75 | 57.75 | 57.75 | 28.9 |
| glycol | | | | | | | |
| Castor Oil | 37.35 | 37.22 | 36.9 | 35.4 | 35.40 | 35.4 | 18.5 |
| Polypropylene | 4.9 | 4.9 | 4.9 | 4.9 | 4.9 | 4.9 | 2.45 |
| Glycol Trimer | | | | | | | |
| Dibutyl Tin | 0 | 0.04 | 0.04 | 0.04 | 0 | 0 | 0.02 |
| Dilaurate | | | | | | | |
| (Catalyst) | | | | | | | |
| CosCAT T-83 ® | 0 | 0 | 0 | 0 | 0.04 | 0 | 0 |
| (Bismuth | | | | | | | |
| catalyst) | | | | | | | |
| Mercapto Silane | 0 | 0 | 0.32 | 0.32 | 0.32 | 0 | 0.16 |
| (Blocking Agent) | | | | | | | |
| Diallyl Phthalate | 0 | 0 | 0 | 1.50 | 0 | 0 | 0 |
| (Olefinic | | | | | | | |
| Compound) | | | | | | | |
| Triethyl amine | 0 | 0 | 0 | 0 | 0 | 0.10 | 0 |
| MEK | 0 | 0 | 0 | 0 | 0 | 0 | 50 |

Flexible laminates (two films) were all prepared similarly with the conditions given above. Example 4 was exposed to radiation prior to passing through the nip. A Nordmeccanica® Super Simplex SL Laminator was used to laminate the films. The two parts of the urethane composition (polyisocyanate and polyfunctional curative) were mixed in the ratio 1:1.9 using meter-mix equipment before coating and lamination. Example 1 contains no catalyst, example 2 contains a tin catalyst and no blocking agent, example 3 contains a tin catalyst and a mercapan blocking agent, example 4 contains a tin catalyst, a mercaptan blocking agent and an olefinic compound, example 5 contains a bismuth catalyst and a mercaptan blocking agent, example 6 contains a tin catalyst and a polyphenol blocking agent and example 7 contains solvent with a tin catalyst and a mercaptan blocking agent. The seven examples with the different urethane compositions were then compared to a commercially available urethane composition (Rohm & Haas C33/1390®). The useable pot life time and the time to urethane adhesive cure in forming the finished flexible laminate was determined for each example. The results are given in Table 3.

TABLE 3
Usable pot life time and time to adhesive cure for the urethane
adhesive compositions used in the flexible laminate.

| | Pot Life Time, Minutes | Time to Cure, |
|---|---|---|
| | (@ 35° C.) | Days |
| Example 1 Adhesive | >120 | 7 |
| Example 2 Adhesive | 25 | 1 |
| Example 3 Adhesive | 80 | 1 |
| Example 4 Adhesive | 80 | 1 |
| Example 5 Adhesive | 70 (@ 40° C., >120 @ 25° C. | 1 |
| Example 6 Adhesive | 80 (@ 40° C.) | 1 |
| Example 7 Adhesive | >120 | 1 |
| Rohm & Haas C33/ | 80 | 7 |
| 1390 ® | | |

Inspection of Table 3 shows that without catalyst (example 1) very long pot life times are achieved; however, the adhesive takes 7 days to cure within the laminate. This long cure time adversely affects flexible laminate production. The commercial adhesive (Rohm & Haas C33/1390®) shows a good pot life of about 80 minutes but still takes about 7 days to cure. With catalyst (example 2) cure times can be reduced to 1 day but pot life is shortened to an unacceptable time of about 25 minutes. With catalyst and blocking agent (example 3) a good balance of pot life (80 minutes) and cure time (1 day) is achieved. This balance of pot life and cure times leads to greatly improved productivity. Use of an olefinic compound with a catalyst and blocking agent (mercaptan) (example 4) leads to good pot life (80 minutes) and a short cure time (1 day).

Use of a bismuth catalyst (example 5) and mercapto blocking agent also provides for long pot life and short cure time. In addition, use of a polyphenol blocking agent (example 6) provides both long pot life and short cure time. Finally, use of a solvent (example 7) in combination with a mercapto blocking agent provides a very long pot life (>120 minutes at 35° C.) and short cure time (1 day).

Overall, the disclosed method of producing flexible laminates provides for improved productivity by allowing for good adhesive pot life times while considerably shortening the cure time of the adhesive in the flexible laminate.

The term “comprising” (and its grammatical variations) as used herein is used in the inclusive sense of “having” or “including” and not in the exclusive sense of “consisting only of”. The terms “a” and “the” as used herein are understood to encompass the pluaral as well as the singular.

The foregoing description illustrates and describes the present disclosure. Additionally, the disclosure shows and describes only the preferred embodiments of the disclosure, but, as mentioned above, it is to be understood that it is capable of changes or modifications within the scope of the concept as expressed herein, commensurate with the above teachings and/or skill or knowledge of the relevant art. The embodiments described hereinabove are further intended to explain best modes known of practicing the invention and to enable others skilled in the art to utilize the disclosure in such, or other, embodiments and with the various modification required by the particular applications or uses disclosed herein. Accordingly, the description is not intended to limit the invention to the form disclosed herein. Also, it is intended that the appended claims be construed to include alternative embodiments.

All publications, patents and patent applications cited in this specification are herein incorporated by reference, and for any and all purposes, as if each individual publication, patent or patent application were specifically and individually indicated to be incorporated by reference. In the case of inconsistencies, the present disclosure will prevail.

What is claimed is:

1. A method of producing a flexible laminate comprising:
(a) applying a urethane adhesive to at least one of at least two flexible substrates wherein the at least two flexible substrates may be the same or different materials;
(b) laminating the at least two flexible substrates with the urethane adhesive between the substrates to form a flexible laminate and
(c) allowing the urethane adhesive to cure forming a flexible laminate wherein the urethane adhesive comprises at least one polyisocyanate, at least one polyfunctional curative, a metallic based catalyst and at least one catalyst blocking agent wherein the at least one catalyst blocking agent comprises a mercapto compound or a polyphenol with adjacent hydroxyl groups or both.

2. The method of producing a flexible laminate as claimed in claim 1, wherein the flexible laminate is heated to accelerate the curing of the urethane adhesive.

3. The method of producing a flexible laminate as claimed in claim 1, wherein the catalyst blocking agent comprises a mercapto compound or a mixture of a mercapto compound and a polyphenol with adjacent hydroxyl groups and wherein the urethane adhesive further comprises an olefinic compound.

4. The method of producing a flexible laminate as claimed in claim 3, wherein the flexible laminate is exposed to actinic radiation or e-beam radiation to accelerate the curing of the urethane adhesive.

5. The method of producing a flexible laminate as claimed in claim 1, wherein the at least two flexible substrates are selected from the group consisting of polyethylene (PE) sheet, polypropylene (PP) sheet, PE/PP sheet oriented PP, metalized PET, mono-axially oriented PP nylon sheet, polyester sheet, mylar sheet, styrenic sheet, polycarbonate sheet, acrylic sheet, acetal sheet, Delrine® sheet, Lexan® sheet, Lucite® sheet, Micarta® sheet, Perspex® sheet, Plexiglas® sheet, Acrylite® sheet, PET sheets, ABS sheet, PVC sheet, PTFE sheet, HIPS sheet, EVOH sheet and PP/EVOH sheet.

6. The method of producing a flexible laminate as claimed in claim 1, wherein the at least one polyisocyanate is selected from the group consisting hexamethylene diisocyanate, hexamethylene diisocyanate trimer, tetramethylxylylene diisocyanate, 4,4′-toluene diisocyanate (TDI), diphenylmethane diisocyanate (MDI), polymethyl polphenyl isocyanate (Polymeric MDI or PAPI), m- and p-phenylene diisocyanates, bitolylene diisocyanate, triphenylmethane triisocyanate, tris-(4-isocyanatophenyl)thiophosphate, cyclohexane diisocyanate (CHDI), bis-(isocyanatomethyl)cyclohexane (H₆XDI), dicyclohexylmethane diisocyanate (H₁₂MDI), trimethylhexane diisocyanate, dimer acid diisocyanate (DDI), dicyclohexylmethane diisocyanate, and dimethyl derivatives thereof, trimethyl hexamethylene diisocyanate, lysine diisocyanate and its methyl ester, isophorone diisocyanate, methyl cyclohexane diisocyanate, methylenedicyclohexane diisocyanate, isophorone diisocyanate, 1,5-naphthalene diisocyanate, triphenyl methane triisocyanate, xylylene diisocyanate and methyl and hydrogenated derivatives thereof, polymethylene polyphenyl isocyanates, chlorophenylene-2,4-diisocyanate and mixtures thereof.

7. The method of producing a flexible laminate as claimed in claim 1, the at least one polyfunctional curative is selected from the group consisting of hydroxypolyesters, hydroxypolyethers, hydroxypolythioesters, hydroxypolyacetals, hydroxypolycarbonates, dimeric fatty alcohols, esteramides, polyetherpolyols, polyesterpolyols, polycarbonatepolyols, ethylene glycol, triethylene glycol, tetraethylene glycol, 1,2- and 1,3-propanediol, 1,4- and 1,3-butanediol, 1,6-hexanediol, 1,8-octanediol, neopentyl glycol, 1,4-bis-(hydroxymethyl)-cyclohexane, bis-(hydroxymethyl)-(tricycle-[5.2.1.0^{2.6}]-decane or 1,4-bis-(2-hydroxyethoxy)-benzene, 2-methyl-1,3-propanediol, 2,2,4-trimethylpentanediol, 2-ethyl-1,3-hexanediol, dipropylene glycol, polypropylene glycols, dibutylene glycol, polybutylene glycols, bisphenol A, tetra-bromobisphenol A, glycerol, trimethylolpropane, 1,2,6-hexanetriol, 1,2,4-butanetriol, pentaerythritol, quinitol, mannitol, sorbitol, methylglycoside 1,4:3,6-dianhydrohexitol and mixtures thereof.

8. The method of producing a flexible laminate as claimed in claim 1, wherein the metallic based catalyst is selected from the group consisting of dibutyltindilaurate, stannous acetate, stannic oxide, stannous octoate, dibutyltin dioctoate, tin mercaptides, stannous citrate, stannous oxylate, stannous chloride, stannic chloride, tetra-phenyl tin, tetra-butyl tin, tri-n-butyl tin acetate, di-alkyl tin dicarboxylates, dimethyl tin dichloride, bismuth tricarboxylates, bismuth nitrate, bismuth halides, bismuth sulfide, basic bismuth dicarboxylates and mixtures thereof.

9. The method of producing a flexible laminate as claimed in claim 1, wherein when the urethane adhesive comprises a mercapto compound as a catalyst blocking agent, the mercapto compound is selected from the group consisting of trimethylol propane tri-(3-mercapto propionate), pentaerythritol tetra-(3-mercapto propionate), glycol di-(3-mercapto propionate), glycol dimercapto acetate, trimethylol propane trithioglycolate, mercapto diethyl ether, ethane dithiol, thiolactic acid, mercapto propionic acid and esters thereof, thiophenol, thio acetic acid, 2-mercapto ethanol, 1,4-butanedithiol, 2,3-dimercapto propanol, toluene-3,4-dithiol, alpha,alpha′-dimercapto-para-xylene, thiosalicylic acid, mercapto acetic acid, dodecane dithiol, didodecane dithiol, di-thio phenol, di-para-chlorothiophenol, dimercapto benzothiazole, 3,4-dimercapto toluene, allyl mercaptan, benzyl mercaptan, 1,6-hexane dithiol, 1-octane thiol, para-thiocresol, 2,3,5,6-tetrafluorothiophenol, cyclohexyl mercaptan, methylthioglycolate, various mercapto pyridines, dithioerythritol, 6-ethoxy-2-mercaptobenzothiazole, d-limonene dimercaptan γ-mercapto silane, and mixtures thereof.

10. The method of producing a flexible laminate as claimed in claim 1, wherein when the urethane adhesive comprises a polyphenol with adjacent hydroxy groups as a catalyst blocking agent, the polyphenol with adjacent hydroxyl groups is selected from the group consisting of catechol, pyrogallol, 3-methoxy catechol, a catechol derivative as shown in formula I 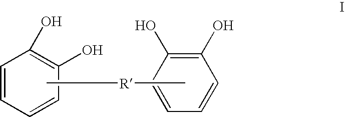
where R′ is a divalent organic group and mixtures thereof.

11. The method of producing a flexible laminate as claimed in claim 3, wherein the olefinic compound is selected from the group consisting of diallyl phthalate, acrylic acid, methacrylic acid alkyl acrylate, alkyl methacrylate, acrylamide and mixtures thereof.

12. The method of producing a flexible laminate as claimed in claim 1, wherein the at least two flexible substrates with the urethane adhesive between the substrates are married by passing through a nip point between two rolls where pressure is applied and wherein one or both of the two rolls are optionally heated.

13. The method of producing a flexible laminate as claimed in claim 4, wherein the at least two flexible substrates with the urethane adhesive between the substrates are married by passing through a nip point between two rolls where pressure is applied, wherein one or both of the two rolls are optionally heated and wherein the at least two flexible substrates with the urethane adhesive between the substrates is exposed to actinic radiation prior to passing through the nip point.

14. The method of producing a flexible laminate as claimed in claim 1, wherein at least one of the at least two flexible substrates contains print.

15. The method of producing a flexible laminate as claimed in claim 14, wherein the at least one of the at least two flexible substrates contains print that is printed by a least one printing method selected from the group consisting of a water-based method, a solvent-based method and radiation-based method.

16. The method of producing a flexible laminate as claimed in claim 1, wherein the urethane adhesive is applied to at least one smooth roll laminating head and then transferred the at least one of the at least two flexible substrates.

17. A flexible laminate material manufactured by the method of producing a flexible laminate as claimed in claim 1.

18. The method of producing a flexible laminate as claimed in claim 1, wherein the urethane adhesive further comprises a solvent.

19. The method of producing a flexible laminate as claimed in claim 18, wherein the solvent is selected from the group consisting of a ketone, MEK, MIBK, an aromatic solvent, toluene, xylene, an aliphatic solvent, hexane, cyclohexane, an ester, ethyl acetate, THF and mixtures thereof.

20. The method of producing a flexible laminate as claimed in claim 1, wherein the urethane adhesive further comprises a tertiary amine.

21. The method of producing a flexible laminate as claimed in claim 20, wherein the tertiary amine is triethylamine, dimethylethylamine, tetramethylethylenediamine, trimethylamine, tributylamine, dimethylbenzylamine, dimethylcyclohexylamine, dimethylethanolamine, diethylethanolamine, triethanolamine, pyridine, 4-phenylpropylpyridine, 2,4,6-collidine, quinoline, tripropylamine, isoquinoline, N-ethylmorpholine, triethylenediamine and mixtures therof.

22. The method of producing a flexible laminate as claimed in claim 1, wherein the flexible laminate is plastic coated with silicon oxide or aluminum oxide.

23. The method of producing a flexible laminate as claimed in claim 1, wherein the metallic based catalyst is based on at least one metal selected from the group consisting of tin, bismuth, germanium, cobalt and manganese.
